(19) United States
(12) Patent Application Publication
(10) Pub. No.: US 2026/0167583 A1
(43) Pub. Date: Jun. 18, 2026

(54) ENHANCED FERTILIZER COMPOSITION AND METHODS OF MANUFACTURE AND USE THEREOF

(71) Applicants: Georg MURRAY, Lebanon, IN (US); Laiduien FAN, Naperville (IL); Joseph FAN, Naperville (IL); Dan O'BRIEN, Brentwood Bay (CA); Andrew SEMPLE, Parrish, FL (US); NANOCHEM SOLUTIONS, INC., Bedford Park, IL (US); INNOVAR AG LLC, Brademon, FL (US)

(72) Inventors: George MURRAY, Lebanon, IN (US); Laiduien FAN, Naperville, IL (US); Joseph FAN, Naperville, IL (US); Dan O'BRIEN, Brentwood Bay (CA); Andrew SEMPLE, Parrish, FL (US)

(21) Appl. No.: 17/769,376

(22) PCT Filed: Oct. 15, 2020
(86) PCT No.: PCT/US2020/055853

§ 371 Date: Apr. 15, 2022

Related U.S. Application Data
(60) Provisional application No. 62/973,583, filed on Oct. 15, 2019.

(51) Int. Cl. C05G 5/30

(52) U.S. Cl. CPC C05G 5/37; C05G 5/30

(57) ABSTRACT

A composition including a granular fertilizer for application to an environment, a urease inhibitor, a nitrification inhibitor, carboxylated polymer, along with a food source of microbial life. In some exemplary embodiments, the composition can further include a water-insoluble physical coating that slows the release of the granular fertilizer into the environment after application. Additionally, a secondary coating can be applied wherein the secondary coating can include one or more alternating layers of an isocyanate and a polyol.

### CROSS-REFERENCE TO RELATED APPLICATION

This Patent Application claims priority to U.S. Provisional Application: 62/973,583 filed Oct. 15, 2019, the disclosure of which is considered part of the disclosure of this application and is hereby incorporated by reference in its entirety.

### FIELD OF THE INVENTION

The invention relates generally to a granular fertilizer composition (enhances nitrogen, phosphate, potassium and combined fertilizers) comprising and by infusing the fertilizer with urease inhibitors, and nitrification inhibitors, carboxylated polymers followed by encapsulation or inclusion of P, K, secondary, and micronutrient uptake enhancers, beneficial soil microbe supporters and physical characteristic improvers. It may also optionally have a secondary encapsulation for even stronger fertilizer granule integrity, and a longer release pattern of the nitrogen and other nutrients optionally a longer release pattern of the nitrogen. The invention also discloses production methodology for manufacture of the invention.

### BACKGROUND

Nitrogen is a critical plant nutrient. In addition to other nutrients, such as phosphorous and potassium, nitrogen is needed to support the growth and development of plant life. Some plants take up elemental nitrogen from the atmosphere and fix this nitrogen into the soil through a symbiotic relationship with Rhizobium bacteria. However, most plants grown to produce human and animal food require the use of nitrogen fertilizer in order to sustain their agricultural production.

The most widely used high-analysis nitrogen fertilizer is granular urea, CO(NH2)2. About 60 million tons per year of urea are produced and used on a variety of crops, such as corn, wheat and rice. When applied to moist soil, the urea becomes a source of ammonia as a result of hydrolysis catalyzed by urease, an enzyme that can be produced by numerous fungi and bacteria. In most soils, the ammonium formed through the hydrolysis of urea is converted to nitrate via bacterial oxidation reactions.

An issue associated with the use of urea as a source of these nitrogen nutrients to support the growth of crop plants relate to the fact that the time frame for the catalytic hydrolysis of urea to ammonia and for the subsequent nitrification of ammonium does not coincide with the ongoing demand for nitrogen by the root system of the plants. Another issue of rapid hydrolysis of urea is the potential for excessive accumulation of ammonia in the soil shortly after seeding that can damage germinating seedlings and young plants. In the agriculture and fertilizer industry, it is known that protecting nitrogen fertilizer from nitrification and volatilization can be beneficial. It is also possible to include nitrification inhibitors and urease inhibitors with phosphate, potassium or combined phosphate, potassium, and nitrogen fertilizers. Many urea, ammonium nitrate, and urea ammonium nitrate fertilizers are formulated with or coated with nitrification and/or urease inhibitors.

One approach to solve this problem has been partially accomplished by incorporating a urease inhibitor or of a nitrification inhibitor into granular urea-containing fertilizers. Urease inhibitors are compounds capable of inhibiting the catalytic activity of the urease enzyme upon urea in moist soil. Somme effective urease inhibitors known include the phosphoric triamide compounds disclosed in U.S. Pat. No. 4,530,714. An example of an effective urease inhibitor disclosed in the '714 patent is N-(n-butyl)thiophosphoric triamide, which will be referred to herein as NBPT. When incorporated into a urea-containing fertilizer, NBPT reduces the rate at which urea is hydrolyzed in the soil to ammonia. The benefits realized as a result of the delayed urea hydrolysis include the following: (1) nutrient nitrogen is available to the plant over a longer period of time, (2) excessive build up of ammonia in the soil following the application of the urea-containing fertilizer is avoided, (3) the potential for nitrogen loss through ammonia volatilization is reduced, (4) the potential for damage by high levels of ammonia to seedlings and young plants is reduced, (5) plant uptake of nitrogen is increased, and (6) an increase in crop yields is attained. While NBPT does not directly influence the rate of ammonium nitrification, it does control the levels of ammonium which are subject to the nitrification process and thereby indirectly controls the levels of nitrate nitrogen in the soil.

An example of the combined use of nitrification inhibitors in urea is a product called SuperU®, sold by Koch Industries which is made by melt processing inhibitors into urea fertilizer. Additionally, it is also well known that improving phosphate fertilizers with micronutrients such as magnesium, boron, copper and others results in an enhanced fertilizer. An example is “Micro-essentials “MES” made by Mosaic.

Accordingly it is an object of the present invention to provide a fertilizer composition for application to an environment that provides high amounts of nitrogen over a longer period of time, thereby minimizing the number of applications of the fertilizer and the excessive accumulation of ammonia in the soil. There exists a need for a fertilizer composition that can provide a slower release of nitrogen to a plant for uptake of a longer period of time.

### BRIEF SUMMARY OF THE INVENTION

In one aspect, this disclosure is related an enhanced fertilizer composition for application to an environment including a granular fertilizer base component, a urease inhibitor, a nitrification inhibitor, carboxylated polymer, along with a food source of microbial life. In some exemplary embodiments, the composition can further include a water-insoluble physical coating that slows the release of the granular fertilizer into the environment after application. According to an exemplary embodiment of the present disclosure, a urease inhibitor, a nitrification inhibitor, and a carboxylated polymer can each compose about 0.03-0.12% by weight of the fertilizer. The microbial food source can compose about 0.12-0.48% by weight of the fertilizer. The composition can further include an optional coating to physically slow the release of the fertilizer which comprise between about 0.5-15% by weight of the fertilizer depending on the amount of time a user would like a slower release of the fertilizer.

In another aspect, this disclosure is related to a method of adding a nutrient up-take or availability enhancer to an exemplary embodiment of a fertilizer composition of the present disclosure. In some exemplary embodiments, the enhanced fertilizer composition of the present disclosure can be applied to an environment at about 1 pound per acre as a potassium or sodium salt, wherein the uptake of nutrients can be increased by about 5-30% over traditional fertilizers.

In yet another aspect, the present disclosure is related to a method for producing an augmented dry nitrogen, phosphate, potassium or combined fertilizer manufactured by first mixing, with or without heat, the fertilizer and a nitrogen loss inhibitor or inhibitors are present as weight per cent totals of between 0.001-5%, followed by mixing at temperatures below 110° C. a nutrient uptake enhancer at a weight percent of between 0.001-5% which can be pre-combined with a solvent also at a weight per cent of between 0.001-5% by weight.

In yet another aspect, the present disclosure is related to an enhanced fertilizer composition including a fertilizer base component including one or more of the following:
nitrogen, phosphate, potassium, wherein the fertilizer base component of the composition comprises between 65-99.3% by weight of the composition, a urease inhibitor comprises between 0.001-5% by weight of the fertilizer composition, a nitrification inhibitor comprises between 0.001-5% by weight of the fertilizer composition, a nutrient up-take component comprises between 0.001-5% by weight of the fertilizer composition, and one or more soil microbe health enhancers, wherein the microbial health enhancers can comprises between 0.001-5% by weight of the fertilizer, wherein all of the components are infused to form an enhanced fertilizer granule. The fertilizer composition can further include a coating applied to the enhanced fertilizer granule, wherein the coating is present at a weight per cent total of between 0.5-15%, wherein said coating comprises a first coating layer and a second coating layer, wherein the first coating layer comprises isocyanate and the second secondary coating layer comprises polyol resins.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present disclosure provides a composition including a granular fertilizer for application to an environment, a urease inhibitor, a nitrification inhibitor, nutrient uptake component, such as a carboxylated polymer, along with a food source for microbial life. In some exemplary embodiments, the composition can further include a water-insoluble physical coating that slows the release of the granular fertilizer into the environment after application. In one embodiment, the fertilizer base component, nitrification inhibitor, urease inhibitor and nutrient up-take component can be mixed together through any suitable means to form an infused granular fertilizer. In some embodiments, the infused granular fertilizer can include a microbe health enhancer or alternatively added as a coating to the infused granular fertilizer.

The present disclosure also provides a method of adding one or more nitrogen loss inhibitors to nitrogen, phosphate, potassium or combined fertilizer, either solid or liquid in form. Additionally, the present disclosure provides a method of adding a nutrient up-take or availability enhancer to an exemplary embodiment of a fertilizer composition of the present disclosure. The present disclosure also provides using a carrier and/or solvent for the nutrient up-take/availability enhancer that may also increase beneficial soil microbe health. An aforementioned carrier and/or solvent can reduce dust and increases water resistance if the fertilizer is in solid form. Furthermore, some exemplary embodiments of the present disclosure can include a final shell coating, which can include but is not limited to urethane, polyvinyl alcohol, polyvinyl acetate or a mixture of the two or similar material for even greater granule strength.

In some exemplary embodiments, the enhance fertilizer composition can include a fertilizer base component, such as urea granules or prill. Similarly, the fertilizer base component can include one or more of the following: nitrogen, phosphate, potassium and can comprise between about 65-99.3% by weight of the enhanced fertilizer composition.

Additionally, the enhanced fertilizer composition can include a urease inhibitor, nitrification inhibitor, and/or nutrient up-take component, wherein the urease inhibitor, nitrification inhibitor, and nutrient up-take component can each compose between 0.001-5% by weight of the fertilizer composition. Furthermore, the composition may include one or more soil microbe health enhancers, wherein the microbial health enhancers can compose about 0.001-5% by weight of the fertilizer. The enhanced fertilizer composition may then be coated with one or more coatings configured to slow the release of the enhanced fertilizer composition. In some exemplary embodiments, the coatings can include first coating layer including an isocyanate and a second coating layer including a polyol resin. The coatings can be alternated any desired number of times depending upon the length of release desired by an end user. In some exemplary embodiments, the alternating coating can be between about 1 and 40 coats, or about 2 and 20 coats, or about 4-16 coats or about 8 coats.

According to some exemplary embodiments of the present disclosure, a urease inhibitor, a nitrification inhibitor, and a carboxylated polymer can each compose about 0.03-0.12% by weight of the enhanced fertilizer composition, and a microbial food source can compose about 0.12-0.48% by weight of the fertilizer. An optional coating can be applied to physically slow the release of the fertilizer and can be between about 0.5-15% by weight of the fertilizer depending on the amount of time one would like a slower release of the fertilizer. In some exemplary embodiments, the base fertilizer component of the composition can comprise about 80.0-99.3% by weight of the composition of the present disclosure. In other embodiments, wherein the composition further includes a secondary coating, the base fertilizer component can comprise about 65-99.3% by weight of the composition of the present disclosure.

In some exemplary embodiments, a nitrification inhibitor and/or urease inhibitor source may be selected from the following group, but is not limited to: 3,4-dimethylpyrazole, 3,4-dimethylpyrazole phosphate, 3,4-dimethylpyrazole sulfate, 3,4-dimethylpyrazole nitrate, 3,4-dimethylpyrazole chloride, 3,4-dimethylpyrazole succinate, 3,4-dimethylpyrazole aspartate, 3,4-dimethylpyrazole polyaspartate, 3,5-dimethylpyrazole, 3,5-dimethylpyrazole phosphate, 3,5-dimethylpyrazole sulfate, 3,5-dimethylpyrazole nitrate, 3,5-dimethylpyrazole chloride, 3,5-dimethylpyrazole succinate, 3,5-dimethylpyrazole aspartate, 3,5-dimethylpyrazole polyaspartate, dicyandiamide, N-(n-Butyl) thiophosphoric triamide (NBPT), phenylphosphorodiamidate (PPD), hydroquinine, neem oil, neem cake, p-benzoquinione, 1,4-benzoquinone, catechol, boric acid, sodium tetraborate pentahydrate, sodium tetraborate decahydrate, anhydrous sodium tetraborate, copper (I) oxide, copper (II) oxide, copper hydroxide, copper carbonate, copper sulfate (and its respective hydrates), copper chloride, copper nitrate, copper EDTA, copper DTPA, copper EDDS, copper IDS, copper citrate, copper-amino acid chelates, cobalt oxide, cobalt hydroxide, cobalt carbonate, cobalt sulfate, cobalt chloride, cobalt nitrate, cobalt EDTA, cobalt DTPA, cobalt EDDS, cobalt IDS, cobalt citrate, cobalt-amino acid chelates, zinc oxide, zinc hydroxide, zinc carbonate, zinc sulfate, zinc chloride, zinc nitrate, zinc EDTA, zinc DTPA, zinc EDDS, zinc IDS, zinc citrate, zinc-amino acid chelates or mixtures thereof.

Additionally, in some exemplary embodiments, the enhanced fertilizer composition may further include one or more micronutrients. The micronutrients include but are not limited to: boron (B), copper (Cu), iron (Fe), manganese (Mn), molybdenum (Mo), zinc (Zn), nickel (Ni), cobalt (Co) and chloride (Cl).

The composition can further include one or more of monomers, polymers and co-polymers capable of slowing crystal formation between positively and negatively charged fertilizer and soil ions. Often referred to as carboxylated oligomers or carboxylated polymers (depending on the molecular weight), these materials enhance the availability and uptake of all plant nutrients both macro and micro. They may be commonly referred to as nutrient uptake enhancers. These can be used in tandem with macronutrients such as nitrogen, phosphorus and potassium as well as micronutrients listed above.

The nutrient up-take component can include various carboxylated oligomer and/or polymer sources may be for example, but by no means limited to: carboxylated oligomers and polymers containing an amine group (such as polyaspartate, polyglutamate, polyanhydroaspartic acid etc.), and carboxylated oligomers and/or polymers not containing an amine group (such as polyepoxysuccinic acid, polymaleic acid, polyitaconic acid etc.), and copolymers thereof. In some exemplary embodiments, the carboxylated polymer can each compose about 0.03-0.12% by weight of the composition. In some exemplary embodiments, the carboxylated polymer can include polyaspartic acid. In one exemplary embodiment the nutrient up-take component can be potassium polyaspartate.

Furthermore, the health of beneficial soil microbes is critical to optimum soil fertility. Microbial health can be supported by ensuring that readily available food sources are present. In one exemplary embodiment, molasses can be used to “feed” beneficial soil microbe populations when applied as part of a fertilizer program.

Additionally, several of the following can be both solvents for carboxylated oligomers and polymers and readily available food sources for beneficial soil microbes. The micronutrient or microbe health enhancer component of the composition of the present disclosure can include but are not limited to: glycerol, erythritol, arabitol, xylitol, ribitol, mannitol, sorbitol, galactitol, fucitol, iditol, inositol, volemitol, isomalt, maltitol, lactitol, maltotriitol, maltotetraitol, polyglycitol, fructose, glucose, sucrose, maltose, lactose, lactulose, trehalose, cellobiose, chitobiose, isomaltose, turanose, melibiose, xylobiose, sophorose, mannibiose, fruto-oligosaccharides, galacto-oligosaccharides, Isomalto-oligosaccharides, maltotriose, manna-oligosaccharides, raffinose, stachyose, verbascose, starch, dextrin, maltodextrin, chondroitin sulfate, and mixtures thereof either put together synthetically, or present in molasses, barley malt extract, sugar beet extract, and other plant byproducts. In some exemplary embodiments, the microbe health enhancer component can compose about 0.1%-0.4%.

In some exemplary embodiments, after or concurrent with treating fertilizer with a composition of the present disclosure having one ore more nitrification/urease inhibitors, one or more nutrient up-take enhancers can be dissolved in materials that support microbial health and can be added to the fertilizer composition. In other embodiments, the composition can include both nitrification/urease inhibitors and nutrient up-take enhancers. One exemplary embodiment of the present disclosure can include a urease inhibitor including but not limited to NBPT, a nitrification inhibitor including but not limited to DCD, and a nutrient up-take enhancer including but not limited to polyaspartate. In other exemplary embodiments, a nitrification inhibitor and urease inhibitor can be infused with a fertilizer material including but not limited to urea. A urea base fertilizer component can be in any suitable form. A first primary coating can be applied to a base fertilizer component, wherein the first primary coating can be a nutrient up-take enhancer, such as a carboxylated polymer. One or more secondary coatings can then optionally be applied. In some exemplary embodiments, the secondary coatings can include alternating coatings of an isocyanate and a polyol resin.

Solid nitrogen, phosphate, potassium and combined fertilizers can have negative physical attributes which may need to be limited. These components are friable into smaller particles or even into dust during transport and application, and can attract water quickly, reducing flowability and clogging machinery. In some exemplary embodiments, these fertilizer components can be coated granules with a poly-vinyl alcohol or similar materials to harden the granule and slow the absorption of water prior to application on soil.

Many of the solvents and mixtures for carboxylated oligomers and polymers disclosed above can also be capable to harden granules and reduce dust. One or more of the polymers and/or mixtures of these polymers can be useful in supporting soil microbe health. In some exemplary embodiments, the composition can include the use of a first coating of a carboxylated oligomers and/or polymer solvents that support soil microbial health, reduce dust and increase granule hardness. In some exemplary embodiments an enhancing composition that can include a water-soluble carboxylated polymer can be applied along with a urease inhibitor and/or a nitrification inhibitor to a urea prill as a first coating. In other embodiments, the enhancing composition can be infused with the urea/fertilizer composition prill or granule composition. Similarly, various embodiments of the present disclosure may include an infused fertilizer base component with a nitrification inhibitor and a urease inhibitor that is later coated with a nutrient-up take component and microbe health component. Additionally, some embodiments can be further harden the granules or fertilizer composition that have been coated or infused with the enhancing composition with a secondary coating of polyvinyl alcohol, polyvinyl acetate, polyurethane, or mixtures thereof and/or one of the other fertilizer granule coatings. This second coating can compose about 0.5%-15 % of the weight of the final composition granule. In some exemplary embodiments, the secondary coating can include multiple secondary coats, wherein one or more secondary coating materials are alternated between a first secondary coating material and a second secondary coating material. In one exemplary embodiment, the first secondary coating material can be isocyanate and the second secondary coating material can be a polyol resin. The secondary coating material can be alternated any suitable number of times. In one exemplary embodiment, the secondary coating materials can alternate to form between about 2-20 layers.

Similarly, specific ratios, rates, and different molecular weights of polyvinyl alcohols, polyvinyl acetates and urethanes can increase the insoluble coating of the fertilizer. The additional second coating can extend the physical release of the fertilizer base component by up to about 1-12 weeks or about 2-8 weeks, or about 4 weeks.

In addition to polyvinyl alcohols and polyvinyl acetates, sulfurs, resins, and ceramic coatings can also be used as secondary coatings to provide a physical barrier to the release of the nitrogen. Various ceramic coatings and resins can allow for different release patterns of the nitrogen into the environment. These coatings can include by way of example, but are not limited to: isocyanate, and polyols. In some exemplary embodiments, a fertilizer base component, such as urea, can be infused or combined with an enhancing composition, using any suitable means such as through heating in a blender and sprayed. The enhancing composition that may contain a urease inhibitor, nitrification inhibitor, and a nutrient up-take component, such as a carboxylated polymer. In some exemplary embodiments, each of the urease inhibitor, nitrification inhibitor, and carboxylated polymer can be added to the fertilizer base component at a ration of between about 1-4.5 lbs. per ton of fertilizer base component. This can account for the enhancing components added to the fertilizer base component at a ration of between about 3:2000 to about 14:2000 enhancing components to fertilizer base. In other exemplary embodiments, the enhancing composition can be mixed with the urea granules in a cosolvent and infused directly into the urea and then mixed until the enhanced composition and urea have dried in the a final composition including a base fertilizer component, urease inhibitor, nitrification inhibitor, and a carboxylated polymer. In other embodiments, the enhancing composition can function as a first/primary coating composition that can be applied to the fertilizer base component and form a coating around the base fertilizer composition or granule.

Optionally, some exemplary embodiments of the present disclosure may include a secondary coating can be applied to the dried enhanced fertilizer composition. In some embodiment, the secondary coating can be applied by spraying alternating layers of one or more secondary coating materials, such as alternating first secondary coating material and second secondary coating material. In some embodiments, the first secondary coating material and second secondary coating material can be applied in a 1:1 ratio as separate coating layer to the enhanced fertilizer product or granule. In one exemplary embodiment, the first secondary coating material can be an isocyanate and the secondary coating material can be a polyol.

Without any limitation as to ingredient choice, ingredient ratios or manufacturing method, a preferred form of the invention is:

### Example #1

With or without heat a fertilizer material, such as urea can be infused with 2 quarts per ton of about 26.7% NBPT and about 20% DCD by weight carried in DMSO and or optionally propylene glycol. Infusion takes place in, but is not limited to, rotary drum or other similar equipment. The combined materials can be tumbled as they cool if heat was used. At a temperature below about 110° C., down to room temperature, a first coating composition which can be comprised of about 1-2 quarts per ton of 20% by weight potassium polyaspartate in 80% by weight glycerol can be sprayed into the tumbler as tumbling continues until the granules are dry. After the first water-soluble coating of a carboxylated polymer (potassium polyaspartate) is added, an optional secondary coating of about 1% polyvinyl alcohol (PVA) by weight may or may not be added and tumbled dry prior to packaging the finished product for shipping. In some embodiments, the secondary coating can be applied multiple times and alternated between a first secondary coating layer of an isocyanate and a second secondary coating layer of a polyol resin. The secondary coating can comprise a weight per cent total of between 0.001-5%.

### Example #2—

In another exemplary embodiment of a liquid composition of the present disclosure can include example of the preferred liquid composition can include a liquid nitrogen fertilizer at room temperature combined with about 2 quarts per ton of about 26.7% NBPT and about 20% DCD by weight carried in DMSO and propylene glycol. After moderate stirring, about 1-2 quarts per ton of about 20% by weight potassium polyaspartate in 80% by weight glycerol can be added to the mixture and stirred moderately before being dried and packaged for shipping.

### Example #3

Using the finished material from example 3 without the PVA additive, a slow release secondary coating may be applied. In a drum mixer, add one ton of the finished material from example 2. The fertilizer can be heated to about 170 degrees F. Once the fertilizer is heated about 1.125% isocyanate by weight can be sprayed onto the fertilizer and blended for about 2 minutes. Additionally, about 1.125% polyol resin by weight can be sprayed onto the fertilizer and blended for about 12 minutes. This process can be repeated between 1 to about 4 times to apply about 4.5% isocyanate and about 4.5% polyol resin by weight respectively for a total of about 9.0% by weight total coating. In some embodiments, about 0.5% secondary coating by weight can be applied and blended at room temperature for 15 minutes. The secondary coating can be any suitable material including but not limited to wax, polyvinyl alcohols and polyvinyl acetates, sulfurs, resins, and ceramic coatings. In some exemplary embodiments, the secondary coating composition can be about 0.5% to about 15% by weight of the final enhanced fertilizer product depending upon the desired length of release curve of the slow-release fertilizer.

### Example #4

In another exemplary embodiment a base fertilizer component such as a liquid nitrogen fertilizer at room temperature can be combined with between about 1-4 quarts per ton of a urease inhibitor, such as about 26.7% NBPT and between about 1-4 quarts per ton of nitrification inhibitor, such as about 20% DCD by weight carried in DMSO and propylene glycol. After moderate stirring, between about 1-4 quarts per ton of a nutrient up-take component, such as about 20% by weight potassium polyaspartate in 80% by weight glycerol, can be added to the mixture and stirred moderately before being dried to form an infused enhanced fertilizer composition of the present disclosure.

### Example #5

In one exemplary embodiment, using the finished material from example 4, a slow release secondary coating may be applied and comprise between about 0.001-15% of the total weight of the final fertilizer composition. In one exemplary embodiment, one ton of the finished fertilizer material from example 4 can be added to a drum mixer. The fertilizer can be heated to about 170° F. Once the fertilizer is heated, between about 0.5-1.5% of a first coating material by weight can be sprayed onto the fertilizer and blended for about 2 minutes. Additionally, between 0.5-1.5% of a second coating material by weight can be sprayed onto the fertilizer and blended for about 12 minutes. This process can be repeated between 1 to about 4 times to apply between 1-8% first coating material and between about 1-8%second coating by weight respectively for a total of about 12% by weight total coating. The first and second coating materials can be any suitable material including but not limited to wax, polyvinyl alcohols and polyvinyl acetates, sulfurs, resins, and ceramic coatings. In some exemplary embodiments, the first coating material is isocyanate, and the second coating material is a polyol resin.

The enhanced fertilizer compositions of this disclosure can be applied to an environment such as a field crop, turf field, or any other ground condition in a single surface application and can supply sufficient nitrogen to the plants throughout their growth and maturing cycles. The enhanced composition increases the nitrogen uptake by plants and minimizes the loss of both ammonium nitrogen and nitrate nitrogen from the soil. In some exemplary embodiments, the enhanced fertilizer composition of the present disclosure can be applied to an environment at about 1 lb. per acre, wherein the uptake of nutrients can be increased by about 5-30% over traditional fertilizers.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A fertilizer composition for application to an environment, comprising:
a fertilizer base component including one or more of the following: nitrogen, phosphate, potassium;
a urease inhibitor;
a nitrification inhibitor; and
a nutrient up-take component.

2. The fertilizer composition of claim 1, further comprising one or more soil microbe health enhancers.

3. The fertilizer composition of claim 2, wherein the urease inhibitor, nitrification inhibitor, and nutrient up-take component can each compose between 0.03-0.12% by weight of the fertilizer composition.

4. The fertilizer composition of claim 3, wherein the microbial health enhancers can compose about 0.12-0.48% by weight of the fertilizer.

5. The fertilizer composition of claim 4, further comprising a coating configured to physically slow the release of the fertilizer composition, wherein the coating is between 0.5-15% by weight of the fertilizer composition.

6. The fertilizer composition of claim 5, wherein the fertilizer base component of the composition can comprise between 65-99.3% by weight of the composition.

7. The fertilizer composition of claim 5, wherein the urease inhibitor and nitrification inhibitor are infused with the fertilizer base component to form an enhanced fused fertilizer composition and the nutrient uptake component is applied to the enhanced infused fertilizer composition as a primary coating.

8. The fertilizer composition of claim 5, wherein the coating is comprised of alternating a first coating layer and a second coating layer, wherein the first secondary coating layer comprises of isocyanate and the second secondary coating layer comprises polyol resins.

9. The fertilizer composition of claim 1 wherein the fertilizer is coated with a water-insoluble physical coating configured to slow the release of the fertilizer base component into the environment after application.

10. The fertilizer composition of claim 1 wherein the nitrification and urease inhibitor is chosen from at least one of the following: 3,4-dimethylpyrazole, 3,4-dimethylpyrazole phosphate, 3,4-dimethylpyrazole sulfate, 3,4-dimethylpyrazole nitrate, 3,4-dimethylpyrazole chloride, 3,4-dimethylpyrazole succinate, 3,4-dimethylpyrazole aspartate, 3-4-dimethylpyrazole polyaspartate, 3,5-dimethylpyrazole, 3,5-dimethylpyrazole phosphate, 3,5-dimethylpyrazole sulfate, 3,5-dimethylpyrazole nitrate, 3,5-dimethylpyrazole chloride, 3,5-dimethylpyrazole succinate, 3,5-dimethylpyrazole aspartate, 3,5-dimethylpyrazole polyaspartate, dicyandiamide (DCD), N-(n-Butyl) thiophosphoric triamide (NBPT), phenylphosphorodiamidate (PPD), hydroquinine, neem oil, neem cake, p-benzoquinione, 1,4-benzoquinone, catechol, boric acid, sodium tetraborate pentahydrate, sodium tetraborate decahydrate, anhydrous sodium tetraborate, copper (I) oxide, copper (II) oxide, copper hydroxide, copper carbonate, copper sulfate (and its respective hydrates), copper chloride, copper nitrate, copper EDTA, copper DTPA, copper EDDS, copper IDS, copper citrate, copper-amino acid chelates, cobalt oxide, cobalt hydroxide, cobalt carbonate, cobalt sulfate, cobalt chloride, cobalt nitrate, cobalt EDTA, cobalt DTPA, cobalt EDDS, cobalt IDS, cobalt citrate, cobalt-amino acid chelates, zinc oxide, zinc hydroxide, zinc carbonate, zinc sulfate, zinc chloride, zinc nitrate, zinc EDTA, zinc DTPA, zinc EDDS, zinc IDS, zinc citrate, zinc-amino acid chelates or mixtures thereof.

11. The fertilizer composition of claim 1 wherein the nutrient up-take component is chosen from at least one of the following: carboxylated oligomers and/or polymers containing an amine group (such as polyaspartate, polyglutamate, polyanhydroaspartic acid etc.), carboxylated oligomers and/or polymers not containing an amine group (such as polyepoxysuccinic acid, etc.).

12. The fertilizer composition of claim 1 wherein the nutrient up-take component is dissolved in solvents chosen from among but not limited to: water, glycerol, tetrahydrofuran, dimethylacetamide, N-methyl-2-pyrrolidone, hexafluoroisopropanol, butylated hydroxytoluene, dimethylformamide, dimethylacetamide, dimethyl sulfoxide, sodium trifluoroacetate, triethylamine, ethanolamine, diethanolamine, triethanolamine, ethylene glycol, propylene glycol, triethylene glycol, triethyl phosphate, eucalyptol, and mixtures thereof.

13. The fertilizer composition of claim 2 wherein the microbe health enhancers are selected from one or more of the following: glycerol, erythritol, arabitol, xylitol, ribitol, mannitol, sorbitol, galactitol, fucitol, iditol, inositol, volemitol, isomalt, maltitol, lactitol, maltotriitol, maltotetraitol, polyglycitol, fructose, glucose, sucrose, maltose, lactose, lactulose, trehalose, cellobiose, chitobiose, isomaltose, turanose, melibiose, xylobiose, sophorose, mannibiose, fruto-oligosaccharides, galacto-oligosaccharides, Isomalto-oligosaccharides, maltotriose, manna-oligosaccharides, raffinose, stachyose, verbascose, starch, dextrin, maltodextrin, chondroitin sulfate, and mixtures thereof either put together synthetically, or present in molasses, barley malt extract, sugar beet extract, and other plant byproducts.

14. The fertilizer composition of claim 1, wherein the nitrification inhibitor is present as weight per cent totals of between 0.001-5%.

15. The fertilizer composition of claim 1, wherein the nutrient up-take enhancer is present as weight per cent totals of between 0.001-5%.

16. The fertilizer composition of claim 2, wherein the soil microbe health enhancer is present as a weight percent total of between 0.001-5%.

17. The fertilizer composition of claim 1, including a coating present at a weight per cent total of between 0.001-5% of the fertilizer composition.

18. The fertilizer composition of claim 1, including a coating selected from a group consisting of a polyvinyl alcohol, polyvinyl acetate, sulfur, resin, and/or ceramic coating present at a weight per cent total of between 0.001-5%.

19. A fertilizer composition for application to an environment, comprising:
a fertilizer base component including one or more of the following: nitrogen, phosphate, potassium, wherein the fertilizer base component of the composition comprises between 65-99.3% by weight of the composition.
a urease inhibitor comprises between 0.001-5% by weight of the fertilizer composition.
a nitrification inhibitor comprises between 0.001-5% by weight of the fertilizer composition; and
a nutrient up-take component comprises between 0.001-5% by weight of the fertilizer composition; and
one or more soil microbe health enhancers, wherein the microbial health enhancers can comprises between 0.001-5% by weight of the fertilizer, wherein all the fertilizer base component, urease inhibitor, nitrification inhibitor, nutrient up-take inhibitor, and soil microbe health enhancer are combined together to form an infused enhanced fertilizer granule.

20. The fertilizer composition of claim 20, wherein the enhanced fertilizer granule further comprises a coating, wherein said coating comprises between 0.5-15% by weight of the fertilizer composition, wherein said coating comprises a first coating layer and a second coating layer, wherein the first coating layer comprises isocyanate and the second secondary coating layer comprises polyol resins.
